(19) United States
(12) Patent Application Publication
(10) Pub. No.: US 2026/0153128 A1
(43) Pub. Date: Jun. 4, 2026

(54) STATIC SEALING SYSTEM IN A SEALING SHIELD FOR ROLLING BEARINGS AND ASSOCIATED ROLLING BEARING OR ASSOCIATED WHEEL HUB UNIT

(71) Applicant: AKTIEBOLAGET SKF, GOTEBORG (SE)

(72) Inventors: Daniele DUCH, San Gillio (IT); Riccardo NARDICCHIA, Torino (IT)

(21) Appl. No.: 19/395,127

(22) Filed: Nov. 20, 2025

(30) Foreign Application Priority Data
Dec. 3, 2024 (IT) 102024000027366

(51) Int. Cl. F16C 33/78; F16C 19/18

(52) U.S. Cl. CPC F16C 33/7886; F16C 19/18; F16C 33/7823; F16C 33/783; F16C 2326/02

(57) ABSTRACT

A static sealing device for sealing a bearing of a vehicle wheel hub unit includes an annular support having a cylindrical axial end portion, an elastomeric sealing element mounted to and at least partially surrounding the annular support and having a first portion located directly radially inward of the axial end portion and a second portion located axially beyond an axial end of the annular support, a first annular protrusion projecting radially inward from the second portion of the elastomeric sealing element and configured to form an interference fit with an annular seat of a radially outer surface of a rolling bearing outer ring, and a second annular protrusion projecting radially inward from the first portion of the elastomeric sealing element and configured to form an interference fit with the annular seat of the radially outer surface of the rolling bearing outer ring.

### CROSS-REFERENCE

This application claims priority to Italian patent application no. 102024000027366 filed on December 3, 2025, the contents of which are fully incorporated herein by reference.

### TECHNOLOGICAL FIELD

The present disclosure relates to a static sealing system which can be applied to and/or /form a part of a sealing shield for rolling bearings. The disclosure also relates to a rolling bearing, in particular a rolling bearing that is integrated in or constitutes a vehicle wheel hub unit.

### BACKGROUND

US 2015036957 A1 discloses a sealing device, such as a seal or a plug, installed on the outer surface of an outer ring of a rolling bearing, in particular a rolling bearing forming part of, or constituting, a vehicle wheel hub unit.

These sealing devices are coupled radially on the outside of the outer ring, generally on the side of the outer ring facing towards a wheel support flange secured to the inner ring of the rolling bearing. It is therefore necessary to secure a static sealing system between a sleeve-shaped mounting portion of the sealing device and an annular seat formed on the radially outer lateral surface of the outer ring of the bearing.

The static sealing is ensured by a portion of an elastomeric sealing element forming part of the sealing device that has a single annular protrusion which comes into contact with a curved connecting surface of an end of the annular seat formed on the outer ring. The annular elastomer protrusion, being coupled with an interference fit with at least part of the mentioned curved surface, produces a combined axial and radial static seal. An example of such a type of static sealing is schematically depicted in the attached FIG. 3, which therefore reflects the prior art.

A disadvantage of this sealing system stems from the machining tolerances with which the outer ring is necessarily produced. The radially outer lateral surface of the outer ring adjacent to the curved terminal surface of the annular seat is not machined and therefore has a forging finish. Consequently, the circumferential profile of the outer ring can be very different from the one envisaged in design, which negatively influences the compression of the annular protrusion, which is not uniform. In fact, even if the axial position and the radius of the curved terminal surface of the annular seat comply with the design, the forged outer profile creates unexpected operating conditions as a result of the process tolerances, with the sealing element not functioning under optimal conditions.

There may, in fact, be the negative effects. For example, the distribution of the sealing pressure may be far from what was intended. This can lead to degraded sealing performance. In addition, unexpected reaction forces may occur during the interference fit assembly of the sealing device on the annular seat of the outer ring. This may result in irregular deformation of the annular protrusion and result in degraded sealing performance and greater friction.

### SUMMARY

The present disclosure is intended to provide a static sealing system which can be applied to or form part of a sealing shield for rolling and that does not have the drawbacks described above. The disclosure also provides a rolling bearing that forms part of or constitutes a vehicle wheel hub unit having an improved static sealing system.

An aspect of the disclosure comprises a static sealing device for sealing a rolling bearing of a vehicle wheel hub unit. The static sealing device comprises an annular support having a substantially cylindrical axial end portion having an axial end and an elastomeric sealing element mounted to and at least partially surrounding the annular support. The sealing element has a first portion located directly radially inward of the axial end portion of the annular support and a second portion located axially beyond the axial end of the annular support. A first annular protrusion projects radially inward from the second portion of the elastomeric sealing element and is configured to form an interference fit with an annular seat of a radially outer surface of a rolling bearing outer ring, and a second annular protrusion projects radially inward from the first portion of the elastomeric sealing element and is configured to form an interference fit with the annular seat of the radially outer surface of the rolling bearing outer ring.

### BRIEF DESCRIPTION OF THE DRAWINGS

The disclosure is described below with reference to the attached drawings, which show two non-limiting example embodiments thereof, in which:

FIG. 1 is a schematic sectional view of a vehicle wheel hub unit constituted by a rolling bearing having a pair of opposite mounting flanges and having a the sealing system according to an embodiment of the present disclosure.

FIG. 2 is an enlarged detail view of a portion of FIG. 1.

FIG. 3 is a schematic sectional view of part of a prior art sealing system.

FIG. 4 is a schematic sectional view of a portion of a first embodiment of a sealing system according to the present disclosure.

FIG. 5 is a schematic sectional view of a portion of a second embodiment of a sealing system according to the present disclosure, drawn to the same scale as the embodiment of FIG. 4.

### DETAILED DESCRIPTION

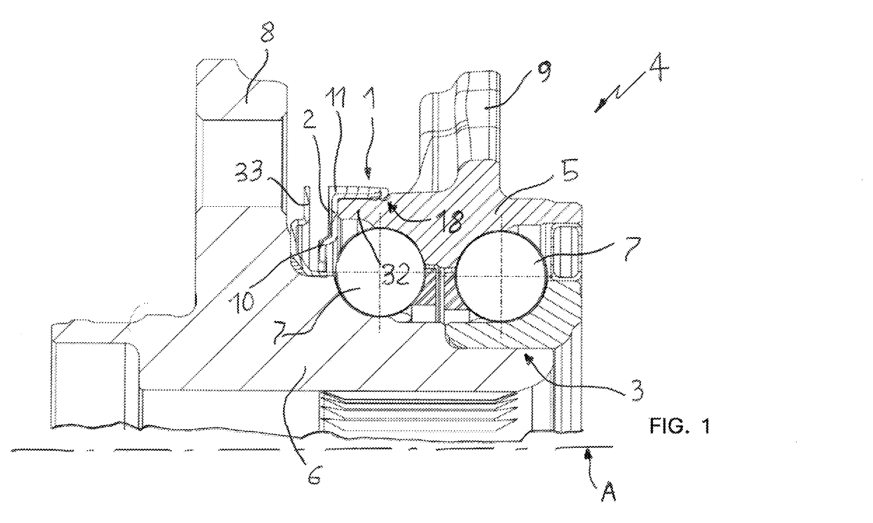

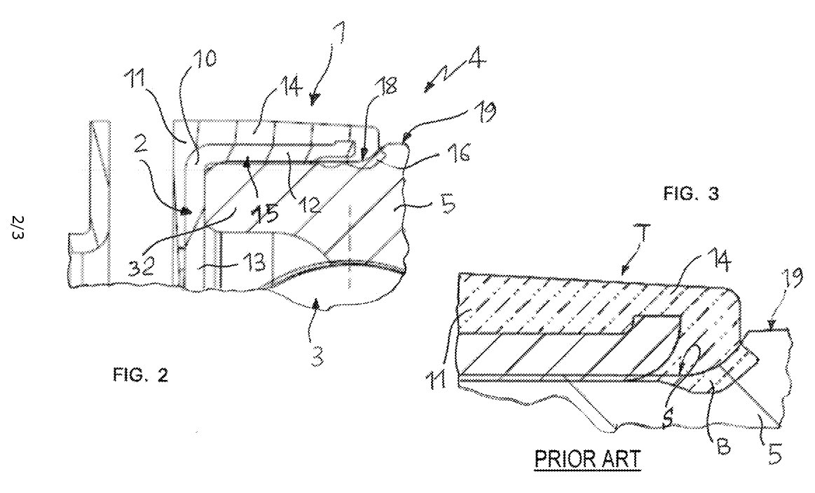

With reference to FIGS. 1 and 2, reference sign 1 denotes, as a whole, a static sealing system configured for a sealing device 2 of a rolling bearing 3. In the non-limiting example shown, the rolling bearing 3 forms part of or, better still, constitutes a vehicle wheel hub unit 4, which is known as a whole.

Specifically, the rolling bearing 3 comprises a radially outer ring 5, a radially inner ring 6, and a plurality of rolling bodies 7 interposed between the outer ring 5 and the inner ring 6 to make them relatively rotatable with low friction. The sealing device 2 is attached securely to the outer ring 5, and a first mounting flange 8 is formed in one piece with the inner ring 6, radially on the outside thereof, and configured to receive, in use, a vehicle wheel, which is known and not shown for simplicity. A second mounting flange 9 is formed in one piece with the outer ring 5, radially on the outside thereof, and configured to be connected, in use, to a vehicle suspension pillar, which is known and not shown for simplicity.

Essentially, the rolling bearing 3 is of the “double-flanged” type, so as to, by itself, constitute the entire wheel hub unit 4. According to different possible embodiments, which are not shown for simplicity, the wheel hub unit 4 could, however, comprise a rolling bearing without any flanges or with only the flange 9, whereas the flange 8 could be formed securely with a spindle of the traditional type, on which the inner ring 6 is mounted angularly and securely. Here and below, while remaining generally applicable, reference will be made to the embodiment in which the rolling bearing alone constitutes the wheel hub unit 4.

The sealing device 2 comprises an annular support 10, which is substantially rigid and generally metallic, and an annular elastomeric sealing element 11 coupled securely to the annular support 10, for example by bonding during vulcanization. The annular support 10 comprises (FIG. 2) a substantially cylindrical sleeve portion 12 and a flange portion 13 which extends radially on the inside from the sleeve portion 12, on the same side as the flange 8, which it faces.

The annular elastomeric sealing element 11 incorporates (encloses, surrounds) at least part of the annular support 10 to which it is secured, and with which it forms, in the non-limiting example shown, a sealing shield of the labyrinth type (FIG. 1) constituting the sealing device 2. The annular elastomeric sealing element 11 has a radially outer end portion 14, which at least partially incorporates the sleeve portion 12 to which it is secured. The end portion 14 and the sleeve portion 12 form, together, a sleeve-shaped mounting portion 15 of the sealing device 2 as a whole.

In the non-limiting example shown, the static sealing system 1 is a specific configuration of an axial end portion of the sealing device 2 and in some embodiments, the static sealing system 1 includes portions of a radially outer surface of an outer bearing ring 5. The static sealing system 1 thus may be described as being located between the sealing device 2 and the outer ring 5 and it may comprise a part of both. In other possible embodiments, not shown for simplicity, the static sealing system 1 of the disclosure in any case cooperates, directly or indirectly, with the outer ring 5.

The end portion 14 of the elastomeric sealing element 11 comprises, radially on the inside, a radial first annular protrusion 16 projecting with respect to the sleeve portion 12 of the annular support 10, radially on the inside of the latter. The annular protrusion 16 is configured to be coupled with an interference fit, in use, with an annular seat 18 formed on a radially outer lateral surface 19 of the outer ring 5.

As compared to the present disclosure, a sealing system T of the prior art, shown schematically and only for visual comparison in FIG. 3, also has an end portion 14 of an elastomeric sealing element 11 provided radially on the inside with an annular protrusion B, shown schematically in a non-deformed configuration, which is coupled with an annular seat S formed on the radially outer lateral surface 19 of the outer ring 5.

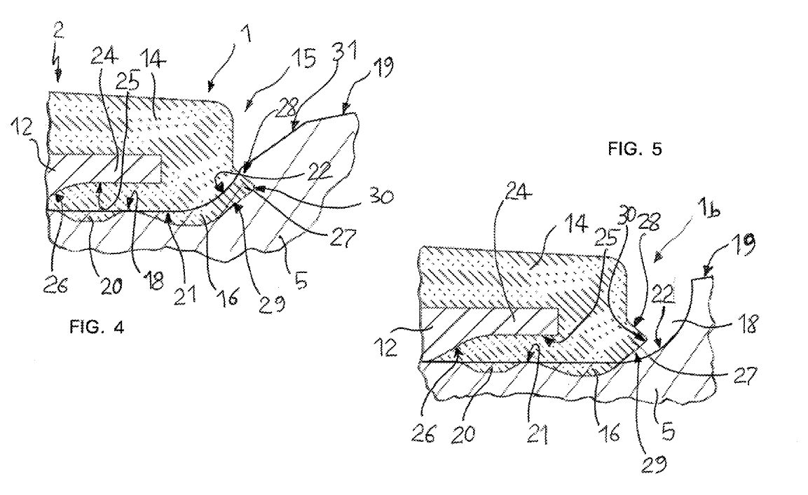

According to a first aspect of the disclosure (FIGS. 2 and 4), the end portion 14 of the elastomeric sealing element 11 comprises a second annular protrusion 20 which is also configured to be coupled with an interference fit, in use, with the annular seat 18, as explained below.

The seat 18 is substantially step-shaped and comprises (FIGS. 4 and 5) a substantially cylindrical bottom wall 21 and a curved frontal end surface 22 forming a first axial shoulder facing towards the flange 8.

According to one aspect of the disclosure, the second annular protrusion 20 is arranged axially farther than the first annular protrusion 16 from the curved end surface or axial shoulder 22 of the annular seat 18. That is, the first annular protrusion 16 is located axially between the second annular protrusion 20 and the curved frontal surface 22.

In the embodiment in FIG. 4, the annular protrusion 16 is in fact arranged to cooperate with an interference fit both axially and radially against the shoulder surface 22, thus immediately adjacent to the curved surface 22, whereas, in the embodiment in FIG. 5, in which the sealing system of the disclosure is indicated by the reference number 1b, the annular protrusion 16 is arranged adjacent to, but axially spaced from, the curved end surface 22 of the seat 18. Nevertheless, in both embodiments, the first annular protrusion 16 is closer than the second annular protrusion 20, in an axial direction, to the curved end surface 22 of the seat 18.

According to another aspect of the disclosure, the second annular protrusion 20 is located directly radially inward of a substantially cylindrical end 24 of the sleeve portion 12 of the annular support 10. Furthermore, the first annular protrusion 16 is formed in one piece with the end portion 14 of the elastomeric sealing element 11 in such a way that it projects axially from the end 24.

According to another aspect of the disclosure, the second annular protrusion 20 projects (FIGS. 4 and 5) from a radially inner lateral surface 25 of the substantially cylindrical end 24 of the sleeve portion 12 of the annular support 10 and has a radial thickness less than that of the first annular protrusion 16.

In practice, whereas the second annular protrusion 20 projects radially from the radially inner lateral surface 25 of the substantially cylindrical end 24 of the sleeve portion 12 of the annular support 10, the first annular protrusion 16 projects radially with respect to, and not from, the radially inner lateral surface 25 of the substantially cylindrical end 24. The first annular protrusion 16 is therefore not located directly radially inward of the inner lateral surface 25 and is arranged so as to project axially with respect thereto. Furthermore, the first annular protrusion 16 projects radially with respect to the lateral surface 25 of the annular support 10 more than the radial projection of the second annular protrusion 20. That is, an inner diameter of the first annular protrusion 16 is less than an inner diameter of the second annular protrusion 20, and the radial projection of the second annular protrusion 20 with respect to the radially inner lateral surface 25 of the tubular end 24 is less than that of the first annular protrusion 16.

Furthermore, the substantially cylindrical distal end 24 of the sleeve portion 12 of the annular support 10 is radially thinner than the rest of the sleeve portion 12 on the side of the sleeve portion 12 facing towards the lateral surface 25, so as to present a curved axial shoulder surface 26 which radially inwardly delimits part of the radially thinned end 24 itself and is arranged immediately adjacent to the second annular protrusion 20, on a side axially opposite to the first annular protrusion 16. In practice, the curved axial shoulder surface 26 faces and is opposite to the curved end surface 22 of the annular seat 18.

The end portion 14 of the elastomeric sealing element 11 completely covers the radially thinned end 24 of the sleeve portion 12 of the annular support 10, so as to be interposed radially between the end 24 of the sleeve portion 12 and the second annular protrusion 20, which projects radially on the inside of the end portion 14 of the elastomeric sealing element 11, being formed in one piece with the same together with the first annular protrusion 16.

According to a preferred embodiment of the disclosure, the first annular protrusion 16 includes an annular axial projection 27 facing towards the curved end surface 22 of the annular seat 18. The axial projection 27 is radially outwardly and inwardly delimited by a pair of opposite substantially conical surfaces, 28 and 29 respectively, that converge together towards a free end 30 of the annular projection 27 forming a continuous annular edge.

In the embodiment in FIG. 4, the annular projection 27 is configured to be fluid-tightly coupled, in use, with the curved end surface 22 of the annular seat 18.

In this embodiment, the static sealing system 1 according to the disclosure further comprises an annular chamfer 31 machined on the radially outer lateral surface 19 of the rolling bearing outer ring 5, at a position immediately adjacent to the curved end surface 22 of the annular seat 18 and radially on the outside thereof. The annular chamfer 31 faces towards the end portion 14 of the elastomeric sealing element 11 so as to converge towards the first annular protrusion 16.

It is clear from the foregoing that the disclosure relates to a rolling bearing, in particular forming part of, or constituting, a vehicle wheel hub unit 4, such as the bearing 3, comprising a radially outer ring 5, a radially inner ring 6, a plurality of rolling bodies 7 interposed between the outer 5 and inner 6 rings, a sealing device 2 borne securely by the outer ring 5 and arranged to protect the rolling bodies 7, and a static sealing system 1 arranged between the sealing device 2 and the outer ring 5 and including elements that form part of both, the sealing device 2, in fact, comprising an annular support 10 and an elastomeric sealing element 11 securely coupled to the annular support 10. The sealing system 1 comprises an annular seat 18 machined on a radially outer surface 19 of the outer ring 5, at a first end 32 thereof (FIGS. 1 and 2); the annular seat 18 comprising a curved end surface 22 arranged, in an axial direction, on the side opposite to the first end 32 of the outer ring 5 and facing towards the first end 32 of the outer ring 5; and a sleeve-shaped mounting portion 15 of the sealing device 2, the mounting portion 15 comprising an end portion 14 of the elastomeric sealing element 11 and a sleeve portion 12 of the annular support 10 securely bearing the end portion 14 of the elastomeric sealing element 11, the end portion 14 of the elastomeric sealing element 11 comprising, for its part, a first annular protrusion 16 which projects from the sleeve portion 12 of the annular support 10 and is coupled with an interference fit with the annular seat 18.

According to the disclosure, the end portion 14 of the elastomeric sealing element 11 comprises a second annular protrusion 20 coupled with an interference fit with the annular seat 18 and this second annular protrusion 20 is arranged axially spaced from the curved end surface 22 of the annular seat 18, whereas the first annular protrusion 16 is axially interposed between the curved end surface 22 of the annular seat 18 and the second annular protrusion 20.

Furthermore, the second annular protrusion 20 forming part of the bearing 3 is flanked, radially on the outside, by the substantially cylindrical end 24 of the sleeve portion 12 of the annular support 10, from which end 24 the first annular protrusion 16 projects axially.

The second annular protrusion 20 has a radial thickness less than that of the first annular protrusion 16, as already indicated, the second annular protrusion projecting radially from the radially inner lateral surface 25 of the substantially cylindrical end 24 of the sleeve portion 12 of the annular support 10 and, in combination, the first annular protrusion 16 projecting radially with respect to the radially inner lateral surface 25 of the substantially cylindrical end 24 of the sleeve portion 12 of the annular support 10 more than the radial projection of the second annular protrusion 20, but not radially overlapping the end 24.

Therefore, the first annular protrusion 16 is not radially flanked on the outside by the substantially cylindrical end 24 of the sleeve portion 12 of the annular support 10, so that at the first annular protrusion 16 the end portion 14 of the elastomeric sealing element 11 is free to elastically deform radially.

The substantially cylindrical end 24 of the sleeve portion 12 of the annular support 10 is radially thinned with respect to the rest of the sleeve portion 12 of the annular support 10, so as to present a curved axial shoulder surface 26 which radially inwardly delimits part of the radially thinned end 24 and is arranged immediately adjacent to the second annular protrusion 20, on a side axially opposite to the first annular protrusion 16.

According to a preferred embodiment, as already indicated, the first annular protrusion 16 comprises an annular axial projection 27 facing towards the curved end surface 22 of the annular seat 18 and radially outwardly and inwardly delimited by a pair of opposite substantially conical surfaces 28 and 29 that converge together towards a free end 30 of the annular projection 27 forming an annular edge.

The conical surface 29 arranged radially towards the inside is configured to facilitate the coupling with an interference fit between the annular seat 18 and the sleeve-shaped mounting portion 15 of the sealing device 2, serving as an “invitation” for elastic deformation when the sealing device 2 as a whole is inserted by sliding and with a radial interference fit into the seat 18, on the side of the first end 32.

By virtue of the feature of having two annular protrusions 16 and 20 arranged in axial sequence, the sealing system 1 provides improved sealing performance. Also, the correct mounting of the sealing device 2, and especially of the sealing system 1, is ensured, since no deformation is produced during mounting, thereby obtaining improved sealability, that is to say improved hydraulic sealing between the sealing device 2 and the outer ring 5. Furthermore, the risk of deformation is reduced which eliminates unexpected contact between the sealing device 2 and other sealing elements, such as a slinger ring 33, which is known (FIG. 1) and arranged against the flange 8 and ensures low friction of the bearing 3.

By virtue of the chamfer 31 in the embodiment in FIG. 4 or the different position of the curved shoulder surface 22 with respect to the annular protrusion 16 in the embodiment in FIG. 5, the static sealing exerted by the sealing system 1 of the disclosure is not influenced by the machining tolerances of the outer ring 5 or by the forging process with which it is obtained.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved sealing systems for rolling bearings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A static sealing device for sealing a rolling bearing of a vehicle wheel hub unit, the static sealing device comprising:
an annular support having a substantially cylindrical axial end portion having an axial end,
an elastomeric sealing element mounted to and at least partially surrounding the annular support and having a first portion located directly radially inward of the axial end portion of the annular support and a second portion located axially beyond the axial end of the annular support,
a first annular protrusion projecting radially inward from the second portion of the elastomeric sealing element and being configured to form an interference fit with an annular seat of a radially outer surface of a rolling bearing outer ring, and
a second annular protrusion projecting radially inward from the first portion of the elastomeric sealing element and being configured to form an interference fit with the annular seat of the radially outer surface of the rolling bearing outer ring.

2. The static sealing device according to claim 1,
wherein a maximum inner diameter of the second annular protrusion is greater than a maximum inner diameter of the first annular protrusion.

3. The static sealing device according to claim 2,
wherein a radial thickness of the axial end portion is less than a radial thickness of a portion of the annular support adjacent to the axial end portion such that a curved shoulder is formed on a radially inner side of the annular support between the axial end portion and the portion of the annular support adjacent to the axial end portion, and
wherein at least part of the second annular protrusion is located directly radially inward of the shoulder.

4. The static sealing device according to claim 3,
wherein the elastomeric sealing element completely covers the axial end portion of the annular support.

5. The static sealing device according to claim 4,
wherein the first annular protrusion is axially separated from the second annular protrusion by a cylindrical portion of the elastomeric sealing element.

6. The static sealing device sealing system according to claim 1,
wherein an axial end of the first annular protrusion includes an annular axial projection having a first substantially conical surface directed radially outwardly and a second substantially conical surface facing radially inwardly, and
wherein the first and second substantially conical surfaces meet to form an annular edge of the first annular protrusion.

7. A system comprising:
a static sealing device according to claim 1, and
the rolling bearing outer ring,
wherein an outer surface of the bearing outer ring includes a cylindrical seat in contact with the second annular protrusion and curved seat spaced from the second annular protrusion.

8. The system according to claim 7,
wherein the first annular protrusion sealingly engages the curved seat.

9. The static sealing device according to claim 8,
wherein the first annular protrusion is axially separated from the second annular protrusion by a cylindrical portion of the elastomeric sealing element.

10. The system according to claim 9,
wherein the outer surface of the bearing outer ring includes a radially outwardly facing conical surface portion axially adjacent to the curved seat.

11. The system according to claim 9,
including a bearing inner ring and a plurality of rolling elements between the bearing inner ring and the bearing outer ring,
wherein the second annular protrusion is axially spaced from the curved seat,
wherein the first annular protrusion is located axially between the curved seat and the second annular protrusion.

12. The system according to claim 11,
wherein a maximum inner diameter of the second annular protrusion is greater than a maximum inner diameter of the first annular protrusion.

13. The system according to claim 12,
wherein a radial thickness of the axial end portion is less than a radial thickness of a portion of the annular support adjacent to the axial end portion such that a curved shoulder is formed on a radially inner side of the annular support between the axial end portion and the portion of the annular support adjacent to the axial end portion, and
wherein at least part of the second annular protrusion is located directly radially inward of the shoulder.

14. The system according to claim 13,
wherein the elastomeric sealing element completely covers the axial end portion of the annular support.

15. The system according to claim 14,
wherein an axial end of the first annular protrusion includes an annular axial projection having a first substantially conical surface directed radially outwardly and a second substantially conical surface facing radially inwardly,
wherein the first and second substantially conical surfaces meet to form an annular edge of the first annular protrusion, and
wherein the annular edge contacts the curved seat.
